(19) United States
(12) Patent Application Publication
(10) Pub. No.: US 2022/0343438 A1
(43) Pub. Date: Oct. 27, 2022

(54) METHODS, DEVICES, AND SYSTEMS FOR BUILDING ON-LINE FRIENDSHIPS

(71) Applicant: That's My Best Friend LLC, Carrboro, NC (US)

(72) Inventor: Dorian Burton, Carrboro, NC (US)

(21) Appl. No.: 17/837,681

(22) Filed: Jun. 10, 2022

Related U.S. Application Data
(63) Continuation of application No. PCT/US20/64418, filed on Dec. 11, 2020.
(60) Provisional application No. 62/947,007, filed on Dec. 12, 2019.

(51) Int. Cl. G06Q 50/00; H04L 67/306

(52) U.S. Cl. CPC G06Q 50/01; H04L 67/306

(57) ABSTRACT

Methods, devices, and systems are disclosed for facilitating friendship building between social networking users. According to one embodiment, a method is implemented on a server for providing first and second users an on-going connection. The method includes receiving first user profile information from a first user computing device and receiving second user profile information from a second user computing device. The method further includes determining a potential match between the first and second users based on the first user profile information and the second user profile information. Next, the method includes receiving a first user acceptance of the potential match from the first user computing device and receiving a second user acceptance of the potential match from the second user computing device. The method also includes sequentially providing a plurality of friendship missions to the first and second users via the first and second users computing devices.

### PRIORITY CLAIM

This application is a continuation of PCT Patent Application No. PCT/US2020/064418 entitled “METHODS, DEVICES, AND SYSTEMS FOR BUILDING ON-LINE FRIENDSHIPS,” (Attorney Docket No. 1116/5 PCT) which was filed on Dec. 11, 2020, which claims benefit of and priority to U.S. Provisional Patent Application No. 62/947,007 entitled “METHODS, DEVICES, AND SYSTEMS FOR BUILDING ON-LINE FRIENDSHIPS,” (Attorney Docket No. 1116/5 PROV), filed on Dec. 12, 2019, the contents of both of which are incorporated by reference herein.

### TECHNICAL FIELD

The present invention relates to a server application, a web application, a mobile device application, and a client/server infrastructure; and more specifically to methods, devices, and systems for providing facilitation of building friendships between a plurality of users.

### BACKGROUND

The popularity of social networking, professional networking, and the on-line marketplace continues to grow. Many online “friends” fail to know each other beyond curated social media highlight reels. Leading dating apps use superficial criteria, and often result producing superficial relationships. However, a lasting relationship does not often start with a swipe right/left or with a match based on simple demographic data. Specifically, mobile users (e.g. smartphone and tablet users) are looking for better ways to meet the right person.

Accordingly, a need exists to better facilitate friendship building between social networking users.

### SUMMARY

The presently disclosed subject matter is directed toward methods, devices, and systems for solving the problem of facilitating friendship building between social networking users. According to one embodiment, a method is implemented on a server for providing a first user and a second user of a plurality of users an on-going connection for facilitating a building of a strong friendship. The method includes receiving first user profile information from a first user computing device and receiving second user profile information from a second user computing device. The method further includes determining a potential match between the first user and the second user based on the first user profile information and the second user profile information. Next, the method includes receiving a first user acceptance of the potential match from the first user computing device and receiving a second user acceptance of the potential match from the second user computing device. The method also includes sequentially providing a plurality of friendship missions to the first user and the second user via the first user computing device and the second user computing device.

According to another embodiment, a server includes a memory, a database, and a processor configured for providing a first user and a second user of a plurality of users an on-going connection for facilitating a building of a strong friendship. The method includes receiving first user profile information from a first user computing device and receiving second user profile information from a second user computing device. The method further includes determining a potential match between the first user and the second user based on the first user profile information and the second user profile information. Next, the method includes receiving a first user acceptance of the potential match from the first user computing device and receiving a second user acceptance of the potential match from the second user computing device. The method also includes sequentially providing a plurality of friendship missions to the first user and the second user via the first user computing device and the second user computing device.

According to another embodiment, a non-transitory computer readable medium includes a plurality of machine-readable instructions. The machine-readable instructions when executed by one or more processors of a server are adapted to cause the server to perform a method server for providing a first user and a second user of a plurality of users an on-going connection for facilitating a building of a strong friendship. The method includes receiving first user profile information from a first user computing device and receiving second user profile information from a second user computing device. The method further includes determining a potential match between the first user and the second user based on the first user profile information and the second user profile information. Next, the method includes receiving a first user acceptance of the potential match from the first user computing device and receiving a second user acceptance of the potential match from the second user computing device. The method also includes sequentially providing a plurality of friendship missions to the first user and the second user via the first user computing device and the second user computing device.

According to another embodiment, a system includes a server and a plurality of mobile devices. The mobile devices are configured to communicate with the server over a network. The server includes a memory, a database, and a processor configured for providing a first user and a second user of a plurality of users an on-going connection for facilitating a building of a strong friendship. The method includes receiving first user profile information from a first user computing device and receiving second user profile information from a second user computing device. The method further includes determining a potential match between the first user and the second user based on the first user profile information and the second user profile information. Next, the method includes receiving a first user acceptance of the potential match from the first user computing device and receiving a second user acceptance of the potential match from the second user computing device. The method also includes sequentially providing a plurality of friendship missions to the first user and the second user via the first user computing device and the second user computing device.

### BRIEF DESCRIPTION OF THE DRAWINGS

The present embodiments are illustrated by way of example and are not intended to be limited by the figures of the accompanying drawings. In the drawings:

FIG. 1 depicts a system implementing the “That's My Best Friend” (TMBF) system as a client/server architecture. (including server, TMBF server application, mobile devices, and TMBF mobile apps) in accordance with embodiments of the present disclosure.

FIG. 2 depicts a flow chart illustrating a user goal to install the TMBF mobile app and setup a user profile. in accordance with embodiments of the present disclosure.

FIG. 3 depicts a flow chart illustrating a user goal of maintaining their basic profile information and interests using the TMBF mobile app in accordance with embodiments of the present disclosure.

FIG. 4 depicts a flow chart illustrating a user goal of finding potential matches using the TMBF mobile app in accordance with embodiments of the present disclosure.

FIG. 5 depicts a flow chart illustrating a user goal of interacting using friendship missions with a potential match using the TMBF mobile app in accordance with embodiments of the present disclosure.

FIG. 6 illustrates an example block diagram of the server of FIG. 1 in accordance with embodiments of the present disclosure.

FIG. 7 illustrates an example block diagram of a mobile device of FIG. 1 in accordance with embodiments of the present disclosure.

FIG. 8 through FIG. 74 depict GUI screens illustrating various user entry and information screens provided by the TMBF mobile app and the TMBF system in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Disclosed herein are methods, devices, and systems for solving the problem of facilitating friendship building between social networking users. Long-term married couples often indicate their love has lasted because they married their best friend. Relationships need strong foundations to have staying power, foundations built from authenticity, the willingness to invest time to get to know one another, and the desire to be students of each other every day.

The “That's My Best Friend” (TMBF) system is a client/server architecture wherein a plurality of users may communicate using their computing devices with a central hub (e.g. server) to create on-going connections for facilitating building of strong friendships. The TMBF server may be a physical server or a virtual server. In other embodiments the TMBF server may be located on a company premise, or located in any other type of datacenter. The TMBF server may also be configured as a plurality of physical servers and/or virtual servers. In some embodiments, an Ubuntu® server may provide the virtual server and may be implemented as a separated operating system (OS) running on one or more physical (i.e. hardware implemented) servers. Any applicable virtual server may by be used for the Ubuntu® Server function. The Ubuntu® server or other server may be implemented within the Microsoft Azure®, Amazon Web Services (AWS®), IBM cloud computing, environment, or the like.

A computing device may be a fixed device or a mobile device. For example, a fixed device may be an interactive kiosk, a personal computer (PC), or the like. A mobile device may be any computing device capable of being transported easily from a one location to another location without undue difficulty and one that is capable of functional connection with a remote server regardless of its location. For example a mobile device may be a smart phone, a tablet, a personal digital assistant, a laptop, or the like. In general, a computing device as used with the TMBF system may be any computing device providing a user input, display, and connectivity to one or more servers over a personal area network (PAN), a local area network (LAN) and/or a wide area network (WAN). The PAN may include Bluetooth® or Universal Serial Bus (USB). The LAN may include any combination of wired Ethernet and/or Wi-Fi access points. The WAN may include the Internet and/or another wide area private network. The WAN may also include any combination of 2G, 3G, 4G, and 5G networks. In some embodiments the WAN may include Data Over Cable Service Interface Specification (DOCSIS) networks and/or fiber networks such as passive optical networks (PONs). Access to the one or more servers may also be provided via a virtual private network (VPN) within any of the previously described networks.

The TMBF system may communicate with the computing devices via an application (“app”) or through a website. In use, a user first downloads the app or goes to the website to register and log onto the TMBF system. In some embodiments, the user registers by creating a unique ID and/or password that identifies the user in the system. The TMBF system may be combined with mobile technology, such that a user may enter the system with a mobile device by simply going to the website and/or opening the app. In some embodiments, users may have the option to login via Google®, Facebook®, LinkedIn®, or the like.

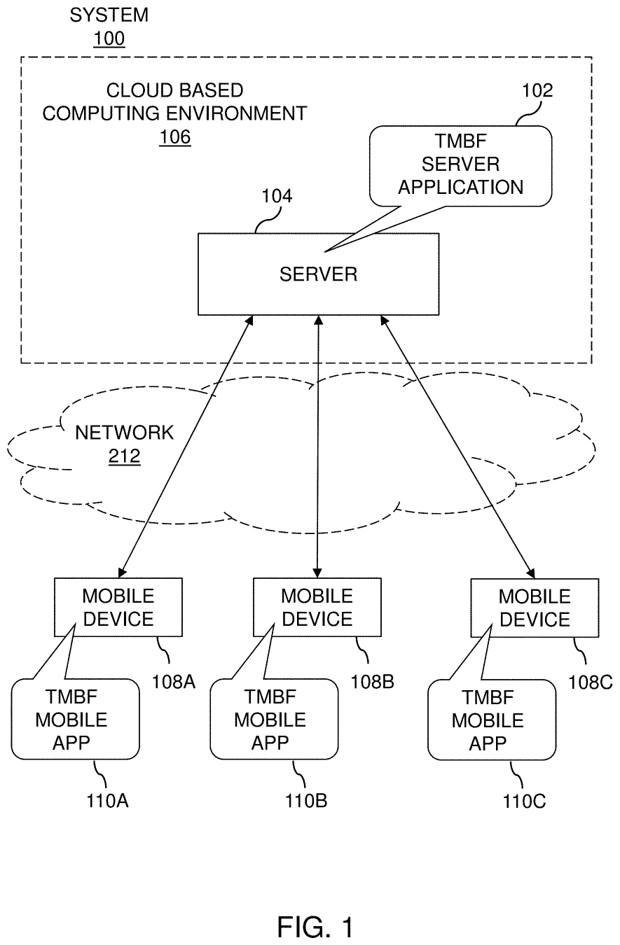

FIG. 1 depicts a system 100 implementing the TMBF system as a client/server architecture. The system 100 includes a TMBF server application 102 hosted on a server 104. The server 104 may be resident in a cloud based computing environment 106. The server 104 may communicate with a plurality of mobile devices 108A-C, hosting a plurality of TMBF mobile apps 110A-C. The mobile devices 108A-C may be smart phones, tablets, smart watches, laptops, or the like. In some embodiments the server 104 may communicate with fixed devices such as an interactive kiosk, a personal computer, or the like. The TMBF mobile apps 210A-C may also be replaced by a web browser in both the fixed and mobile devices. The mobile apps 210A-C may communicate with the TMBF server application 202 over a network 212. The network 212 may be any type or combination of wired, wireless, and/or optical networks.

The server 104 with TMBF server application 102 may perform any of the methods described in the summary and the claims. The TMBF server application 102 transforms the server 104 from a generic computer function into a machine for solving the problem of facilitating friendship building between social networking users.

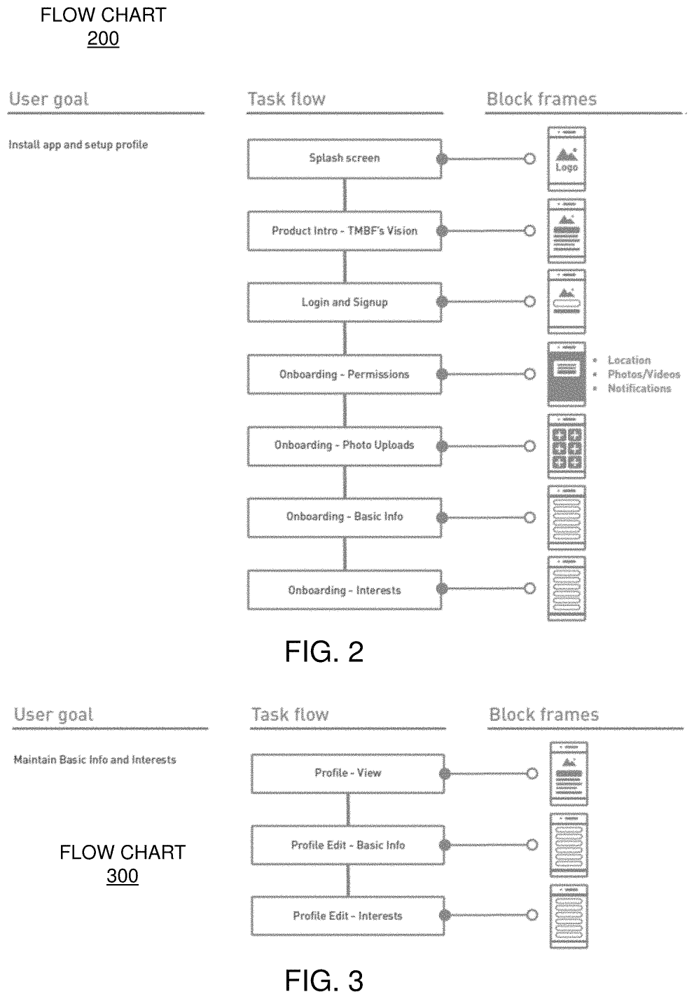

FIG. 2 depicts a flow chart 200 illustrating a user goal to install the TMBF mobile app 110 and setup of a user profile. A task flow includes (1) a splash screen, (2) a product info (including TMBF's vision), a login and signup, onboarding (including permission, photo uploads, basic user information, and user interests).

FIG. 3 depicts a flow chart 300 illustrating a user goal of maintaining their basic profile information and interests using the TMBF mobile app 110. A task flow includes (1) a profile view and profile edit (including basic user information and user interests).

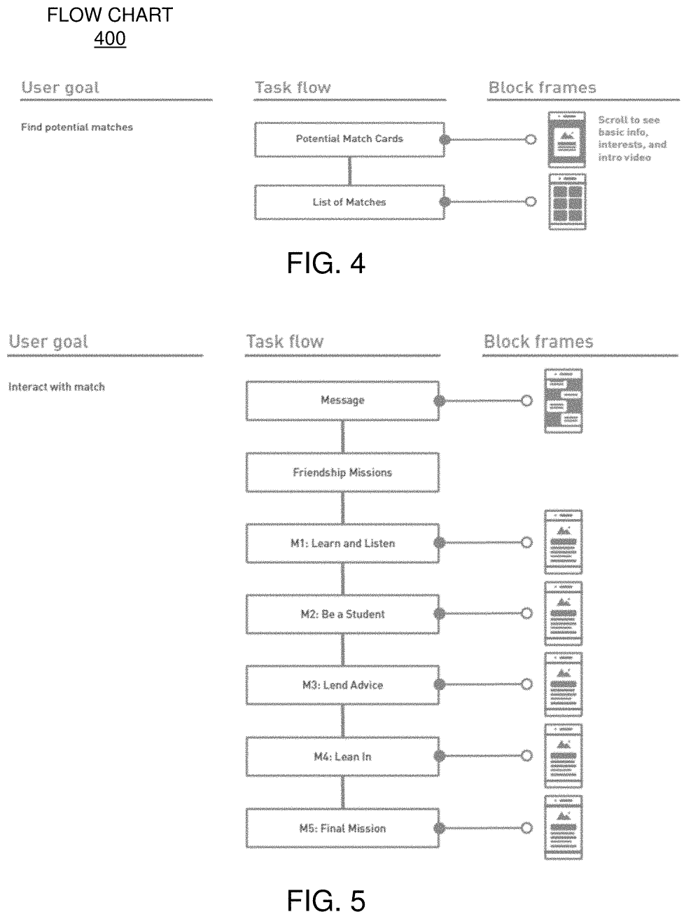

FIG. 4 depicts a flow chart 400 illustrating a user goal of finding potential matches using the TMBF mobile app 110. A task flow includes (1) potential match cards and (2) a list of matches.

FIG. 5 depicts a flow chart 500 illustrating a user goal of interacting using friendship missions with a potential match using the TMBF mobile app 110.

The TMBF system provides tutorials to guide users through their first experience with the TMBF matching process as follows:
The first time the user swipes left to dislike someone, a pop-up appears to confirm that the user indeed is not interested in a potential match with that person.
The first time the user swipes right to like, a pop-up appears to confirm that the user is interested in the potential match.
If users match with someone, a screen appears that celebrates the connection.

The TMBF system provides relationship-building using “Friendship Missions.” Friendship missions are activities that users engage in once a match is made. They allow potential friends to build strong connections before ever meeting in person. The TMBF system provides five friendship missions.

Mission one (M1) is labeled “Learn and Listen”. Mission one asks potential friends to read, watch, or listen to a user-submitted recording in order to learn about the other person.

Mission two (M2) is labeled “Be a student of the person you want to know”. To have a forever relationship, the person should be a forever student, constantly learning their partner. This mission requests two potential friends to record 15-second videos answering a set of open-ended questions. The TMBF system uses open-ended questions to allow a baseline of information between the matched parties. Video provides a more intimate medium for communication. Each user answers all of the questions, and the mission is complete when both parties view all the video questions and answers. Examples may include:
What are your best and worst memories from childhood?
List your three biggest needs.
Which of your friends and family members have the best relationship and why?
What kinds of behaviors annoy you?
What kinds of things keep you awake at night?
What's something you've dreamed of doing but haven't done yet?
When do you feel the most loved?
What would you consider unforgivable and why?
What would make up your perfect day?

Mission three (M3) is labeled “Lend me some advice”. Mission three is based on the belief that relationships require empathy. This mission affords potential friends a small example of the reciprocation that is needed in relationships. Users are prompted to record and upload 3-minute videos describing a problem and then giving their potential friend advice. Both parties need to sign off that the mission has been completed.

Mission four (M4) is labeled “Lean in”. This mission builds friendships through sharing favorite experiences. On their own, each person engages in an activity that the other person enjoys, such as eating at a favorite restaurant or watching a favorite movie. This mission has a heftier time commitment. Both parties need to sign off to confirm mission has been completed.

Mission five (M5), labeled “Final mission,” requires each person to take photographs or purchase three items within a scavenger hunt. Both parties need to sign off and meet in person for the mission to be complete.

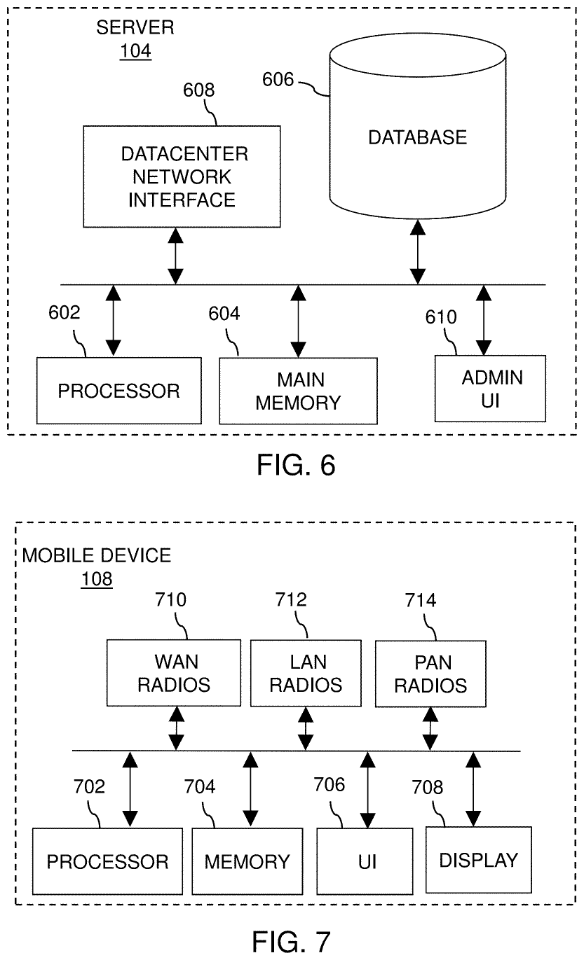

FIG. 6 illustrates an example block diagram of the server 106 of FIG. 1. The server 106 may include at least one of a processor 602, a main memory 604, a storage memory (e.g. database) 606, a datacenter network interface 608, and an administration user interface (UI) 610. The server 106 may be configured to host the Ubuntu® server as discussed earlier. In some embodiments Ubuntu® server may be distributed over a plurality of hardware servers using hypervisor technology.

The processor 602 may be a multi-core server class processor suitable for hardware virtualization. The processor may support at least a 64-bit architecture and a single instruction multiple data (SIMD) instruction set. The main memory 604 may include a combination of volatile memory (e.g. random access memory) and non-volatile memory (e.g. flash memory). The database 606 may include one or more hard drives.

The datacenter network interface 608 may provide one or more high-speed communication ports to the data center switches, routers, and/or network storage appliances. The datacenter network interface 608 may include high-speed optical Ethernet, InfiniBand (IB), Internet Small Computer System Interface (iSCSI), and/or Fibre Channel interfaces. The administration UI may support local and/or remote configuration of the remote server 700 by a datacenter administrator.

FIG. 7 illustrates an example block diagram of the mobile device 108 of FIG. 1. The mobile device 108 may include at least a processor 702, a memory 704, a user interface (UI) 706, a display 708, WAN radios 710, LAN radios 712, and personal area network (PAN) radios 714. In some embodiments, the mobile device 104 may be an iPhone® or an iPad®, using iOS® as an OS. In other embodiments, the mobile device 104 may be a mobile terminal including Android® OS, BlackBerry® OS, Windows Phone® OS, or the like.

In some embodiments, the processor 702 may be a mobile processor such as the Qualcomm® Snapdragon™ mobile processor. The memory 704 may include a combination of volatile memory (e.g. random access memory) and non-volatile memory (e.g. flash memory). The memory 704 may be partially integrated with the processor 702. The UI 706 and display 708 may be integrated such as a touchpad display. The WAN radios 710 may include 2G, 3G, 4G, and/or 5G technologies. The LAN radios 712 may include Wi-Fi technologies such as 802.11a, 802.11b/g/n, and/or 802.11ac circuitry. The PAN radios 714 may include Bluetooth® technologies.

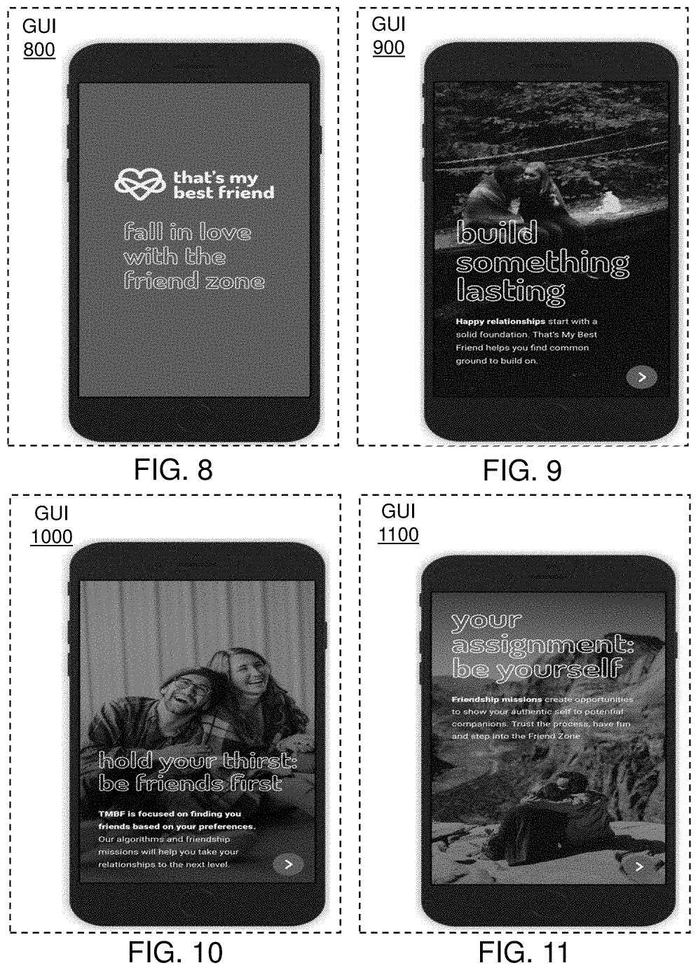

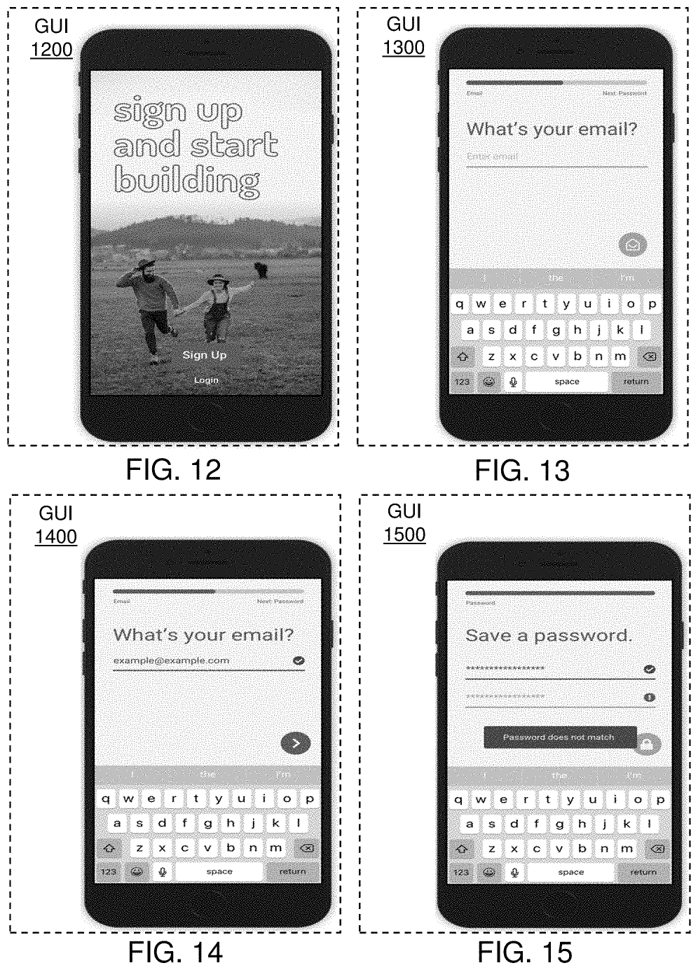

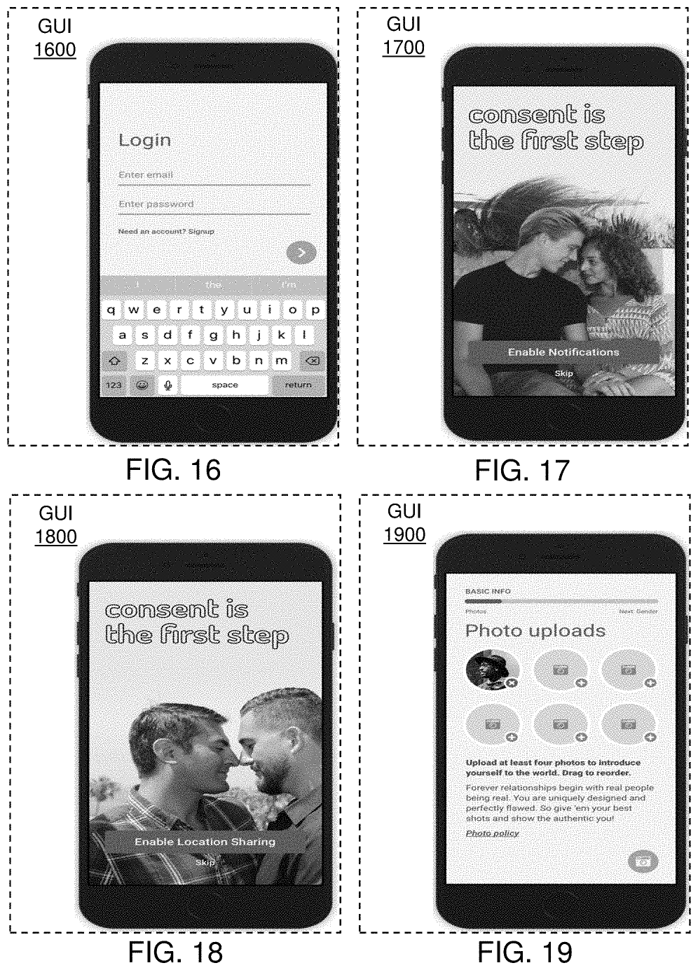

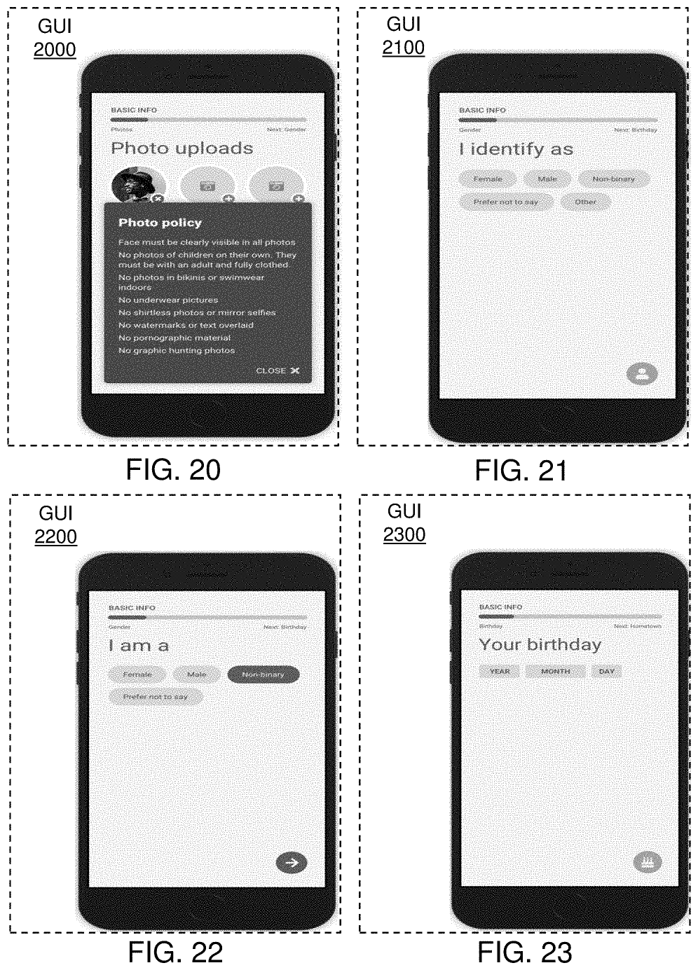

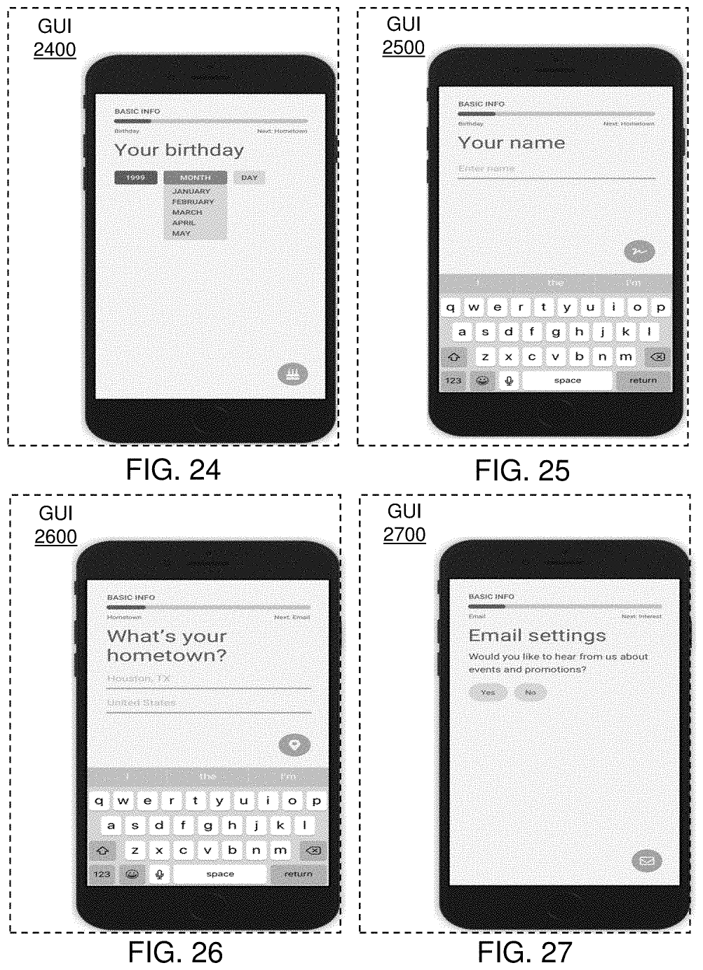

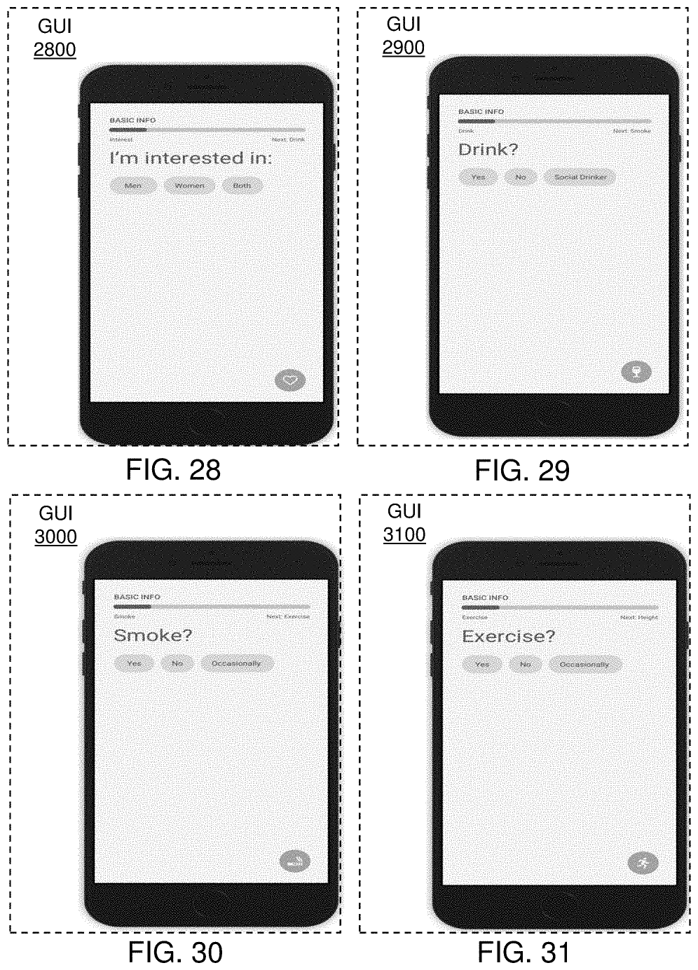

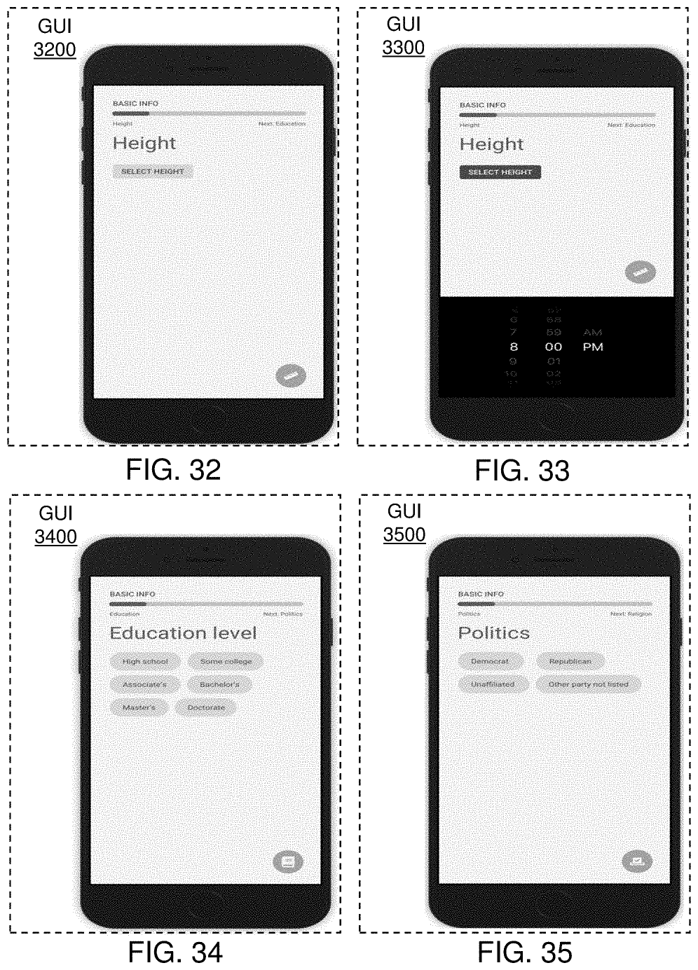

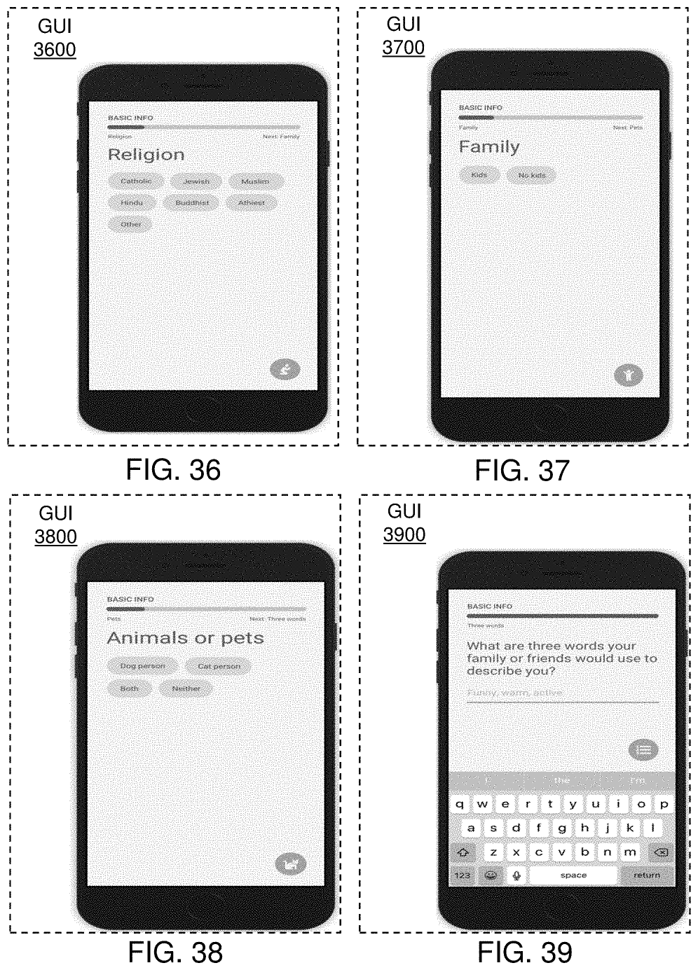

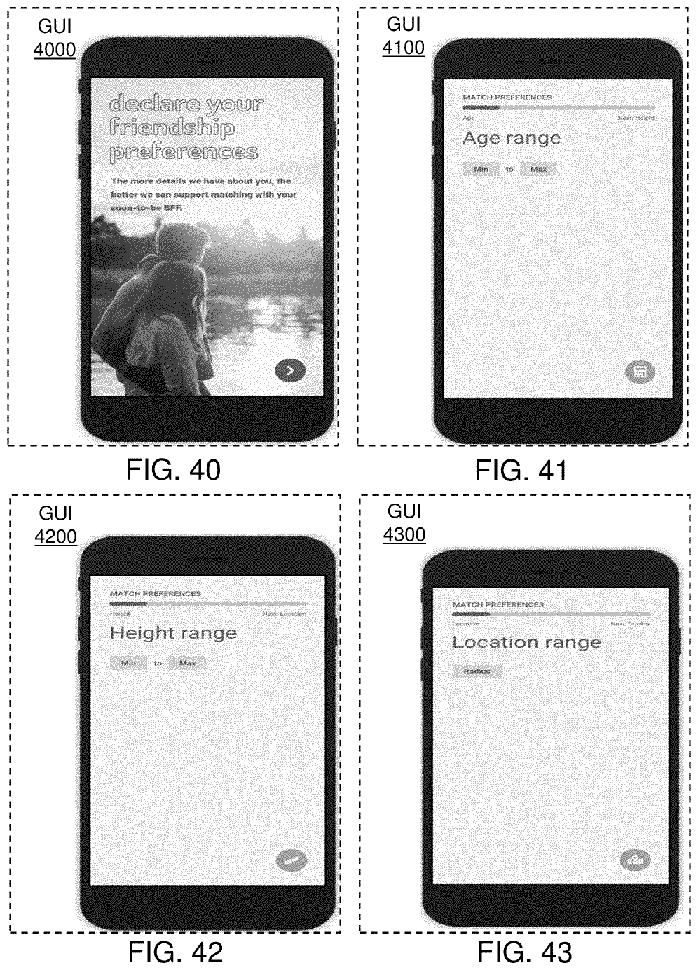

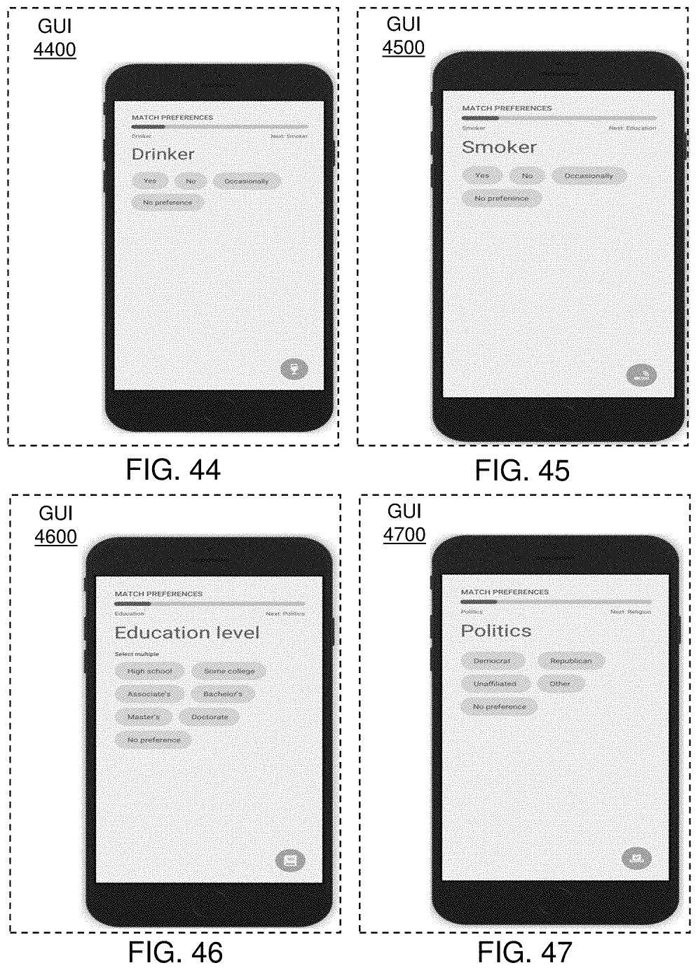

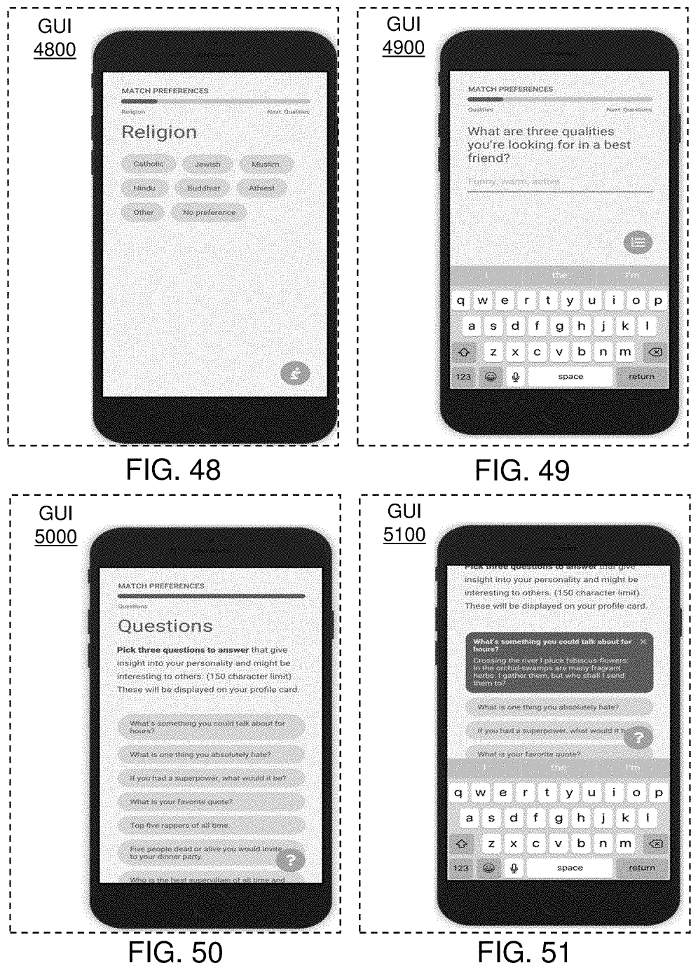

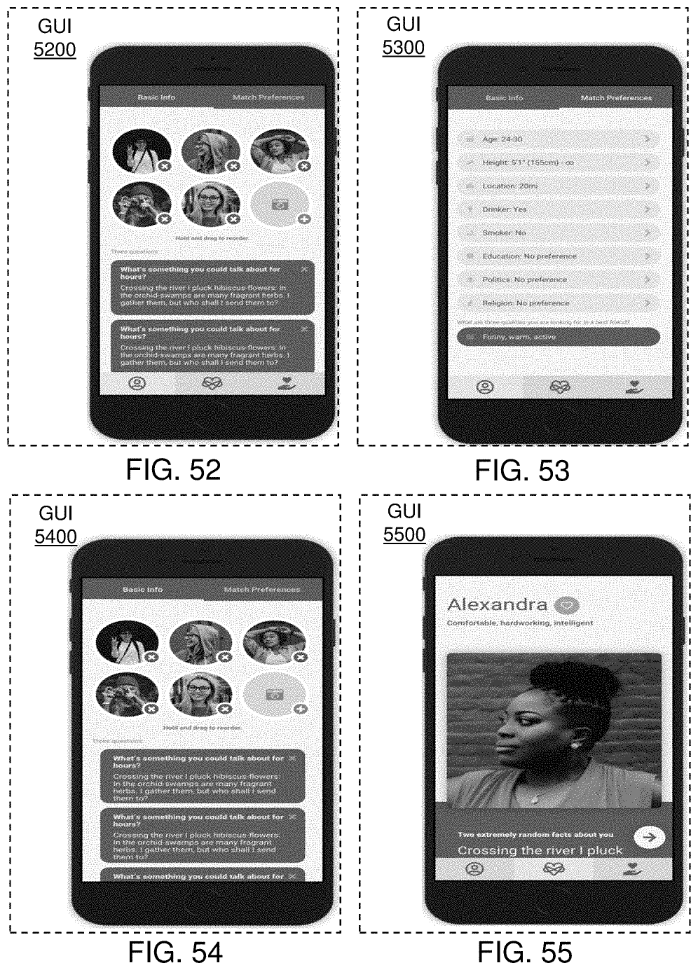

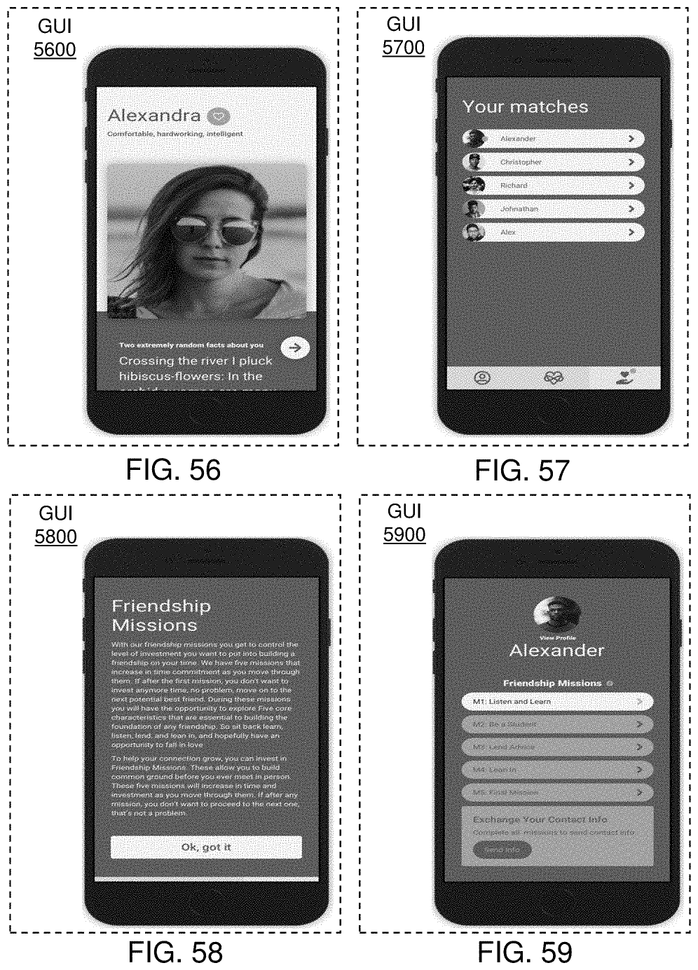

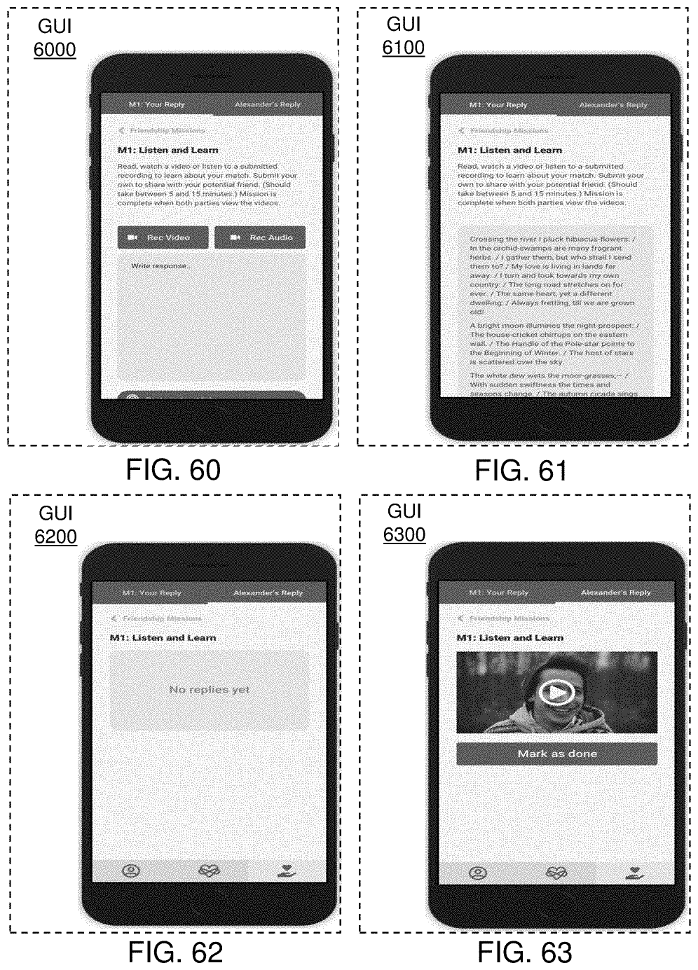

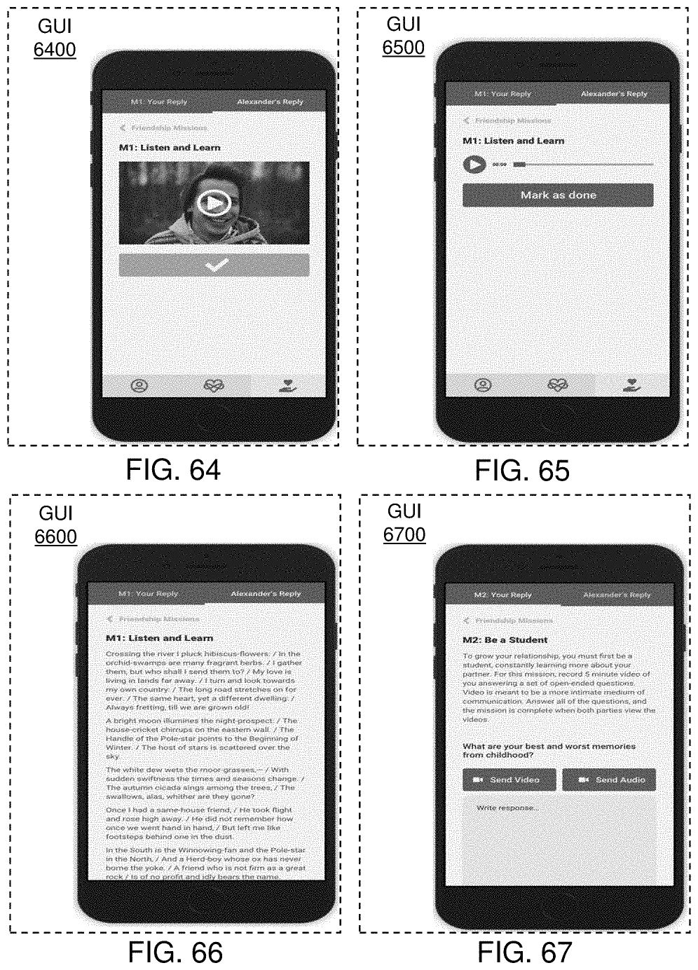

FIG. 8 depicts a GUI 800 running on the TMBF mobile app 110 illustrating a splash screen of the TMBF system.

FIG. 9 depicts a GUI 800 running on the TMBF mobile app 110 illustrating another splash screen including additional vision information about of the TMBF system.

FIG. 10 depicts a GUI 1000 running on the TMBF mobile app 110 illustrating another splash screen including additional vision information about of the TMBF system.

FIG. 11 depicts a GUI 1100 running on the TMBF mobile app 110 illustrating another splash screen including additional vision information about of the TMBF system.

FIG. 12 depicts a GUI 1200 running on the TMBF mobile app 110 illustrating a menu screen including selections for a user to login or sign up to create an account on the TMBF system.

FIG. 13 depicts a GUI 1300 running on the TMBF mobile app 110 illustrating a user email setup screen of the TMBF system.

FIG. 14 depicts a GUI 1400 running on the TMBF mobile app 110 illustrating another user email setup screen of the TMBF system.

FIG. 15 depicts a GUI 1500 running on the TMBF mobile app 110 illustrating a user password setup screen of the TMBF system.

FIG. 16 depicts a GUI 1600 running on the TMBF mobile app 110 illustrating a login screen of the TMBF system.

FIG. 17 depicts a GUI 1700 running on the TMBF mobile app 110 illustrating a screen allowing a user to enable notifications or skip notifications on the TMBF system.

FIG. 18 depicts a GUI 1800 running on the TMBF mobile app 110 illustrating a screen allowing a user to enable location sharing or skip location sharing on the TMBF system.

FIG. 19 depicts a GUI 1900 running on the TMBF mobile app 110 illustrating a screen allowing a user to upload multiple images to the TMBF system.

FIG. 20 depicts a GUI 2000 running on the TMBF mobile app 110 illustrating another screen allowing a user to upload images to the TMBF system that includes the photo policy and photo review.

FIG. 21 depicts a GUI 2100 running on the TMBF mobile app 110 illustrating a user profile screen allow a user to enter gender identification information to the TMBF system including female, male, non-binary, prefer not to say, or other gender identification.

FIG. 22 depicts a GUI 2200 running on the TMBF mobile app 110 illustrating another user profile screen allowing a user to enter actual gender information to the TMBF system including female, male, non-binary, or other gender type.

FIG. 23 depicts a GUI 2300 running on the TMBF mobile app 110 illustrating a user profile screen allowing a user to enter their birthday to the TMBF system including year, month, and day.

FIG. 24 depicts a GUI 2400 running on the TMBF mobile app 110 illustrating another user profile screen allowing a user to enter their birthday information to the TMBF system.

FIG. 25 depicts a GUI 2500 running on the TMBF mobile app 110 illustrating another user profile screen allowing a user to enter their name to the TMBF system.

FIG. 26 depicts a GUI 2600 running on the TMBF mobile app 110 illustrating a user profile screen allowing a user to enter their hometown to the TMBF system.

FIG. 27 depicts a GUI 2700 running on the TMBF mobile app 110 illustrating a user preference screen for email settings including events and promotions for the TMBF system.

FIG. 28 depicts a GUI 2800 running on the TMBF mobile app 110 illustrating another user profile entry screen including match preferences men, women, or both for the TMBF system.

FIG. 29 depicts a GUI 2900 running on the TMBF mobile app 110 illustrating another user profile entry screen including how often they drink for the TMBF system.

FIG. 30 depicts a GUI 3000 running on the TMBF mobile app 110 illustrating another user profile entry screen including how often the smoke for the TMBF system.

FIG. 31 depicts a GUI 3100 running on the TMBF mobile app 110 illustrating another user profile entry screen including how often they exercise for the TMBF system.

FIG. 32 depicts a GUI 3200 running on the TMBF mobile app 110 illustrating another user profile entry screen including their height for the TMBF system.

FIG. 33 depicts a GUI 3300 running on the TMBF mobile app 110 illustrating another user profile entry screen including their height for the TMBF system.

FIG. 34 depicts a GUI 3400 running on the TMBF mobile app 110 illustrating another user profile entry screen for their education including high school, some college, associate's degree, bachelor's degree, master's degree, and/or doctorate degree for the TMBF system.

FIG. 35 depicts a GUI 3500 running on the TMBF mobile app 110 illustrating another user profile entry screen for their political affiliation including Democrat, Republican, unaffiliated, or for an unlisted party for the TMBF system.

FIG. 36 depicts a GUI 3600 running on the TMBF mobile app 110 illustrating another user profile entry screen for their religion including Catholic, Jewish, Muslim, Hindu, Buddhist, Atheist, or other religion for the TMBF system.

FIG. 37 depicts a GUI 3700 running on the TMBF mobile app 110 illustrating another user profile entry screen for family size including kids or no kids for the TMBF system.

FIG. 38 depicts a GUI 3800 running on the TMBF mobile app 110 illustrating another user profile entry screen for animal/pet preference including dog person, cat person, both, or neither for the TMBF system.

FIG. 39 depicts a GUI 3900 running on the TMBF mobile app 110 illustrating another user profile entry screen for allow a user to enter what words their family or friends would use to describe them (for example funny, warm, active, etc.) for the TMBF system.

FIG. 40 depicts a GUI 4000 running on the TMBF mobile app 110 illustrating a splash screen for use match preferences for the TMBF system.

FIG. 41 depicts a GUI 4100 running on the TMBF mobile app 110 illustrating a user entry screen for match preferences including an age range for the TMBF system.

FIG. 42 depicts a GUI 4200 running on the TMBF mobile app 110 illustrating another user entry screen for match preferences including a height range for the TMBF system.

FIG. 43 depicts a GUI 4300 running on the TMBF mobile app 110 illustrating another user entry screen for match preferences including a location range (for example a radius) for the TMBF system.

FIG. 44 depicts a GUI 4400 running on the TMBF mobile app 110 illustrating another user entry screen for match preferences including whether their match should drink for the TMBF system.

FIG. 45 depicts a GUI 4500 running on the TMBF mobile app 110 illustrating another user entry screen for match preferences including whether there match should smoke for the TMBF system.

FIG. 46 depicts a GUI 4600 running on the TMBF mobile app 110 illustrating another user entry screen for match preferences for education for the TMBF system.

FIG. 47 depicts a GUI 4700 running on the TMBF mobile app 110 illustrating another user entry screen for match preferences for politics for the TMBF system.

FIG. 48 depicts a GUI 4800 running on the TMBF mobile app 110 illustrating another user entry screen for match preferences for religion for the TMBF system.

FIG. 49 depicts a GUI 4900 running on the TMBF mobile app 110 illustrating another user entry screen for match preferences including other qualities of the match for the TMBF system.

FIG. 50 depicts a GUI 5000 running on the TMBF mobile app 110 illustrating a user entry screen for user personality information for the TMBF system.

FIG. 51 depicts a GUI 5100 running on the TMBF mobile app 110 illustrating another user entry screen for user personality information for the TMBF system.

FIG. 52 depicts a GUI 5200 running on the TMBF mobile app 110 illustrating a portion of a user's basic information and match preferences screen for the TMBF system.

FIG. 53 depicts a GUI 5300 running on the TMBF mobile app 110 illustrating another portion of a user's basic information and match information for the TMBF system.

FIG. 54 depicts a GUI 5400 running on the TMBF mobile app 110 illustrating another portion of a user's basic information and match information for the TMBF system.

FIG. 55 depicts a GUI 5500 running on the TMBF mobile app 110 illustrating a user's potential match provided by the TMBF system.

FIG. 56 depicts a GUI 5600 running on the TMBF mobile app 110 illustrating another user's potential match provided by the TMBF system.

FIG. 57 depicts a GUI 5700 running on the TMBF mobile app 110 illustrating various matches for a user provided by the TMBF system.

FIG. 58 depicts a GUI 5800 running on the TMBF mobile app 110 illustrating an information screen for the friendship missions provides by the TMBF system.

FIG. 59 depicts a GUI 5900 running on the TMBF mobile app 110 illustrating a selection of the first friendship mission (including listen and learn) of the TMBF system.

FIG. 60 depicts a GUI 6000 running on the TMBF mobile app 110 illustrating an entry screen for a first friendship mission (listen and learn) provided by the TMBF system.

FIG. 61 depicts a GUI 6100 running on the TMBF mobile app 110 illustrating an informational screen for the first friendship mission (listen and learn) provides by the TMBF system.

FIG. 62 depicts a GUI 6200 running on the TMBF mobile app 110 illustrating another informational screen for the first friendship mission (listen and learn) provides by the TMBF system.

FIG. 63 depicts a GUI 6300 running on the TMBF mobile app 110 illustrating an entry screen allowing a user to mark complete for the first friendship mission (listen and learn) provided by the TMBF system.

FIG. 64 depicts a GUI 6400 running on the TMBF mobile app 110 illustrating a screen showing complete for the first friendship mission (listen and learn) provided by the TMBF system.

FIG. 65 depicts a GUI 6500 running on the TMBF mobile app 110 illustrating another entry screen allowing a user to mark complete for the first friendship mission (listen and learn) provided by the TMBF system.

FIG. 66 depicts a GUI 6600 running on the TMBF mobile app 110 illustrating another information screen for the first friendship mission (listen and learn) provided by the TMBF system.

FIG. 67 depicts a GUI 6700 running on the TMBF mobile app 110 illustrating a user entry screen for the second friendship mission (including be a student) provided by the TMBF system.

FIG. 68 depicts a GUI 6800 running on the TMBF mobile app 110 illustrating an information screen for the fifth friendship mission (including a final mission) provided by the TMBF system.

FIG. 69 depicts a GUI 6900 running on the TMBF mobile app 110 illustrating a user entry screen for the fifth friendship mission (final mission including a scavenger hunt) provided by the TMBF system.

FIG. 70 depicts a GUI 7000 running on the TMBF mobile app 110 illustrating an information screen for the fifth friendship mission (scavenger hunt) provided by the TMBF system.

FIG. 71 depicts a GUI 7100 running on the TMBF mobile app 110 illustrating another information screen for the fifth friendship mission (scavenger hunt) provided by the TMBF system.

FIG. 72 depicts a GUI 7200 running on the TMBF mobile app 110 illustrating a user entry screen for providing contact information to a selected potential match provided by the TMBF system.

FIG. 73 depicts a GUI 7300 running on the TMBF mobile app 110 illustrating contact information of a potential match provided by the TMBF system.

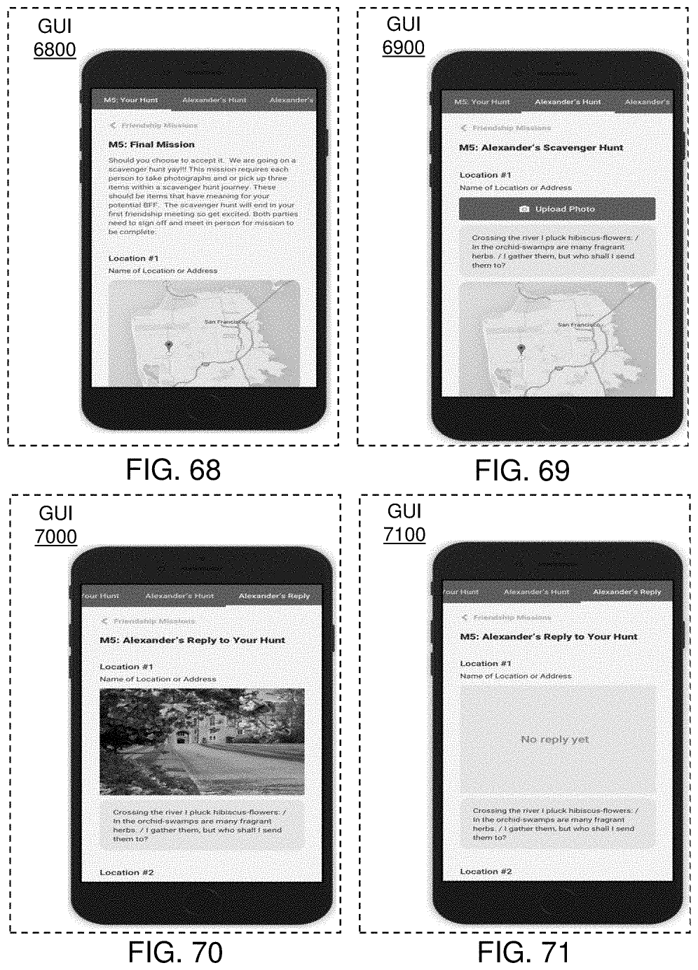

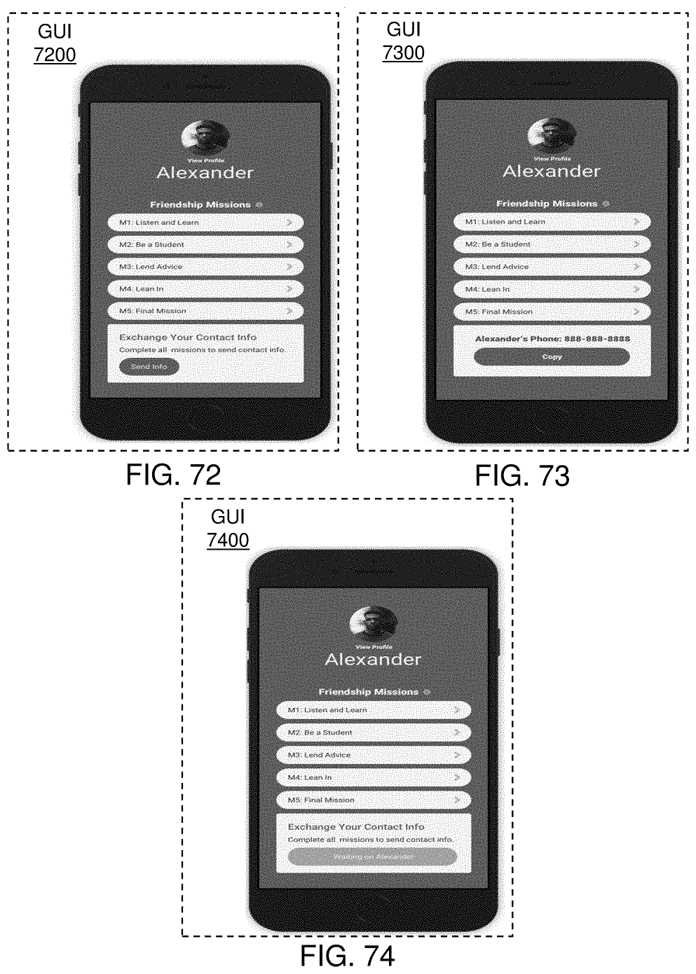

FIG. 74 depicts a GUI 7400 running on the TMBF mobile app 110 illustrating contact status information from a potential match provided by the TMBF system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product (e.g. TMBF server application 102 of FIG. 1) embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented on a server for providing a first user and a second user of a plurality of users an on-going connection for facilitating a building of a friendship, the method comprising
receiving first user profile information from a first user computing device;
receiving second user profile information from a second user computing device;
determining a potential match between the first user and the second user based on the first user profile information and the second user profile information;
receiving a first user acceptance of the potential match from the first user computing device;
receiving a second user acceptance of the potential match from the second user computing device; and
sequentially providing a plurality of friendship missions to the first user and the second user via the first user computing device and the second user computing device.

2. The method of claim 1, wherein a first friendship mission of the plurality of friendship missions comprises:
transmitting a second user introduction to the first user computing device, wherein the second user introduction was submitted by the second user in a format including at least one of a text format, an audio format, and a video format; and
transmitting a first user introduction to the second user computing device, wherein the first user introduction was submitted by the first user in a format including at least one of a text format, an audio format, and a video format.

3. The method of claim 2, wherein a second friendship mission of the plurality of friendship missions comprises:
transmitting a plurality of first user open ended questions to the first user computing device and receiving a plurality of first user answers from the first user computing device, wherein the first user answers are in a format including at least one of a text format, an audio format, and a video format; and
transmitting the first user answers to the second user computing device.

4. The method of claim 3, wherein the second friendship mission of the plurality of friendship missions further comprises:
transmitting a plurality of second user open ended questions to the second user computing device and receiving a plurality of second user answers from the second user computing device, wherein the second user answers are in a format including at least one of a text format, an audio format, and a video format; and
transmitting the second user answers to the first user computing device.

5. The method of claim 3, wherein a third friendship mission of the plurality of friendship missions comprises:
receiving a first user giving advice example from the first user computing device, wherein the first user giving advice example is in a format including at least one of a text format, an audio format, and a video format; and
transmitting the first user giving advice example to the second user computing device.

6. The method of claim 5, wherein the third friendship mission of the plurality of friendship missions further comprises:
receiving a second user giving advice example from the second user computing device, wherein the second user giving advice example is in a format including at least one of a text format, an audio format, and a video format; and
transmitting the second user giving advice example to the first user computing device.

7. The method of claim 5, wherein a fourth friendship mission of the plurality of friendship missions comprises:
transmitting a second user preferred activity example to the first user computing device; and
receiving a first acknowledgement from the first user computing device, wherein the first acknowledgement provides an indication that the first user has recently participated in an activity related to the second user preferred activity example.

8. The method of claim 7, wherein the fourth friendship mission of the plurality of friendship missions further comprises:
transmitting a first user preferred activity example to the second user computing device; and
receiving a second acknowledgement from the second user computing device, wherein the second acknowledgement provides an indication that the second user has recently participated in an activity related to the first user preferred activity example.

9. The method of claim 7, wherein a fifth friendship mission of the plurality of friendship missions comprises:
transmitting first scavenger hunt information to the first user computing device; and
receiving first scavenger hunt fulfilment information from the first user computing device;
transmitting second scavenger hunt information to the second user computing device; and
receiving second scavenger hunt fulfilment information from the second user computing device.

10. The method of claim 9, wherein:
the first scavenger hunt fulfilment information comprises a first plurality of images captured by the first user computing device; and
the second scavenger hunt fulfilment information comprises a second plurality of images captured by the second user computing device.

11. The method of claim 1, wherein the first user computing device is at least one of a smart phone, a tablet, a smart watch, a laptop, and a personal computer.

12. The method of claim 11, wherein the second user computing device is at least one of a smart phone, a tablet, a smart watch, a laptop, and a personal computer.

13. The method of claim 1, wherein the server is a virtual server hosted in a cloud computing environment.

14. The method of claim 1, wherein the server provides a first secure web portal for a first graphical user interface (GUI) of the first user computing device and a second secure web portal for a second GUI of the second user computing device.

15. The method of claim 14, wherein the first GUI is provided by a first application specific program and the second GUI is provided by a second application specific program.

16. The method of claim 15, wherein the first application specific program is at least one of an iOS® app and an Android® OS app and the second application specific program is at least one of an iOS® app and an Android® OS app.

17. The method of claim 14, wherein the first GUI is provided by a first web browser and the second GUI is provided by a second web browser.

18. The method of claim 17, wherein:
the first web browser is at least one of a Microsoft Internet Explorer® browser, a Microsoft Edge® browser, an Apple Safari® browser, a Google Chrome® browser, a Mozilla Firefox® browser, and an Opera® browser; and
the second web browser is at least one of a Microsoft Internet Explorer® browser, a Microsoft Edge® browser, an Apple Safari® browser, a Google Chrome® browser, a Mozilla Firefox® browser, and an Opera® browser.

19. A server for providing a first user and a second user of a plurality of users an on-going connection for facilitating a building of a friendship, the server comprising
a memory;
a database; and
a processor configured for:
receiving first user profile information from a first user computing device;
receiving second user profile information from a second user computing device;
determining a potential match between the first user and the second user based on the first user profile information and the second user profile information;
receiving a first user acceptance of the potential match from the first user computing device;
receiving a second user acceptance of the potential match from the second user computing device; and
sequentially providing a plurality of friendship missions to the first user and the second user via the first user computing device and the second user computing device.

20. A non-transitory computer readable medium comprising a plurality of machine-readable instructions which when executed by one or more processors of a server are adapted to cause the server to perform a method server for providing a first user and a second user of a plurality of users an on-going connection for facilitating a building of a friendship, the method comprising:
receiving first user profile information from a first user computing device;
receiving second user profile information from a second user computing device;
determining a potential match between the first user and the second user based on the first user profile information and the second user profile information;
receiving a first user acceptance of the potential match from the first user computing device;
receiving a second user acceptance of the potential match from the second user computing device; and
sequentially providing a plurality of friendship missions to the first user and the second user via the first user computing device and the second user computing device.
